(19) United States
(12) Patent Application Publication
(10) Pub. No.: US 2014/0253016 A1
(43) Pub. Date: Sep. 11, 2014

(54) MOBILE POWER SUPPLY DEVICE AND POWER SUPPLY SYSTEM THEREOF

(71) Applicant: LI-KUO CHIU, Taipei (TW)

(72) Inventor: LI-KUO CHIU, Taipei (TW)

(21) Appl. No.: 13/941,961

(22) Filed: Jul. 15, 2013

(30) Foreign Application Priority Data
Mar. 8, 2013 (TW) 102204317

(51) Int. Cl. H02J 7/00

(52) U.S. Cl. CPC H02J 7/0054
USPC 320/103

(57) ABSTRACT

A mobile power supply device and a power supply system thereof are disclosed. The mobile power supply device is used for charging a load device. A rectifier circuit of the mobile power supply device is used for receiving an alternating current power to convert to a direct current power. A battery set includes a plurality of battery units series connected to each other. A charging control unit is used for receiving the direct current power to charge the battery set. An output control unit is used for controlling the battery set to output the direct current power to the load device via a direct-current output port. A direct-current input port is used for inputting the direct current power to the battery set, wherein the direct-current input port includes a determining pin for determining whether the charging control unit connects to another mobile power supply device.

### BACKGROUND OF THE INVENTION

1. Field of the Invention

The present invention relates to a mobile power supply device and a power supply system thereof; more particularly, the present invention relates to a mobile power supply device with a series connecting battery set, and a power supply system thereof.

2. Description of the Related Art

As the technology develops, the mobile power supply device has already become an important consumer product in recent years. The mobile power supply device uses the internal lithium battery to provide continuous electricity to the portable electronic device. However, the charging speed of the mobile power supply device of the prior art is slow; when inputting the alternating current power, the mobile power supply device needs to be connected to an additional alternating current and direct current converter as an input power supply; therefore, the mobile power supply device of the prior art is not convenient to use. Besides, the mobile power supply device of the prior art uses a 5 volts direct current power to charge a 3.7 volts lithium battery; to increase the power of the mobile power supply device, the lithium battery must be parallel connected, but it will substantially increase the charging time. Besides, the mobile power supply device of the prior art can only output 5 volts stable voltage, so the suitable portable electric devices are limited. The mobile power supply device must be adjusted additionally to be suitable for the portable electronic devices which require high voltage power supply.

Therefore, there is a need to provide a new mobile power supply device and a power supply system thereof, to solve the disadvantage of the prior art.

### SUMMARY OF THE INVENTION

It is an object of the present invention to provide a mobile power supply device, and the mobile power supply device includes a series connecting battery set.

It is another object of the present invention to provide a power supply system with the abovementioned mobile power supply device.

To achieve the abovementioned object, the mobile power supply device of the present invention receives an alternating current power from a power supply end, to charge a load device. The mobile power supply device includes a rectifier circuit, a battery set, a charging control unit, an output control unit, a direct-current output port, and direct-current input port. The rectifier circuit is used for receiving an alternating current power to convert to a direct current power. The battery set includes a plurality of battery units which are series connected to each other. The charging control unit is electrically connected to the rectifier circuit and the battery set, for receiving the direct current power to charge the battery set. The output control unit is electrically connected to the battery set, to control and adjust the output current and voltage of battery set to the direct-current output port, to provide a safe and stable direct current power to the load device. The direct-current input port is electrically connected to the charging control unit and battery set, for inputting the direct current power to the battery set, wherein the direct-current input port includes a determining pin. The charging control unit determines whether the charging control unit is connected to another mobile power supply device via the determining pin, to further control the connecting method of the battery set to receive the direct current power from another mobile power supply device, and the output method of the direct-current output port.

The power supply system of the present invention is used for charging the load device. The power supply system includes a first mobile power supply device and a second mobile power supply device. The first mobile power supply device includes a first battery set and a first output control unit. The first battery set includes a plurality of first battery units which are series connected to each other. The first output control unit is electrically connected to the first battery set, for controlling the first battery set to output the first direct current power via the first direct-current output port. The second mobile power supply device is electrically connected to the first mobile power supply device. The second mobile power supply device includes a second battery set, a charging control unit, a direct-current input port, and a second output control unit. The second battery set includes a plurality of second battery units which are series connected to each other. The charging control unit is electrically connected to the second battery set. The direct-current input port is electrically connected to the charging control unit, then connected to the second battery set, wherein the direct-current input port includes the determining pin. The charging control unit determines whether the second mobile power supply device is connected to the first mobile power supply device via the determining pin, to further directly output all voltage and current of the first battery set via the first output control unit of the first mobile power supply device. The charging control unit of the second mobile power supply device directly receives the battery electricity from the first mobile power supply device to directly input to the battery of the second mobile power supply device, allowing the output of the electricity and voltage become twice. The second output control unit is electrically connected to the second battery set, for controlling the second battery set to output the second direct current power to the load device via the second direct-current output port.

### BRIEF DESCRIPTION OF THE DRAWINGS

FIG. 1 illustrated a structure schematic drawing of the mobile power supply device of the present invention.

FIG. 2 illustrated a structure schematic drawing of the power supply system with the series connecting mobile power supply device of the present invention.

### DETAILED DESCRIPTION OF THE PREFERRED EMBODIMENT

These and other objects and advantages of the present invention will become apparent from the following description of the accompanying drawings, which disclose several embodiments of the present invention. It is to be understood that the drawings are to be used for purposes of illustration only, and not as a definition of the invention.

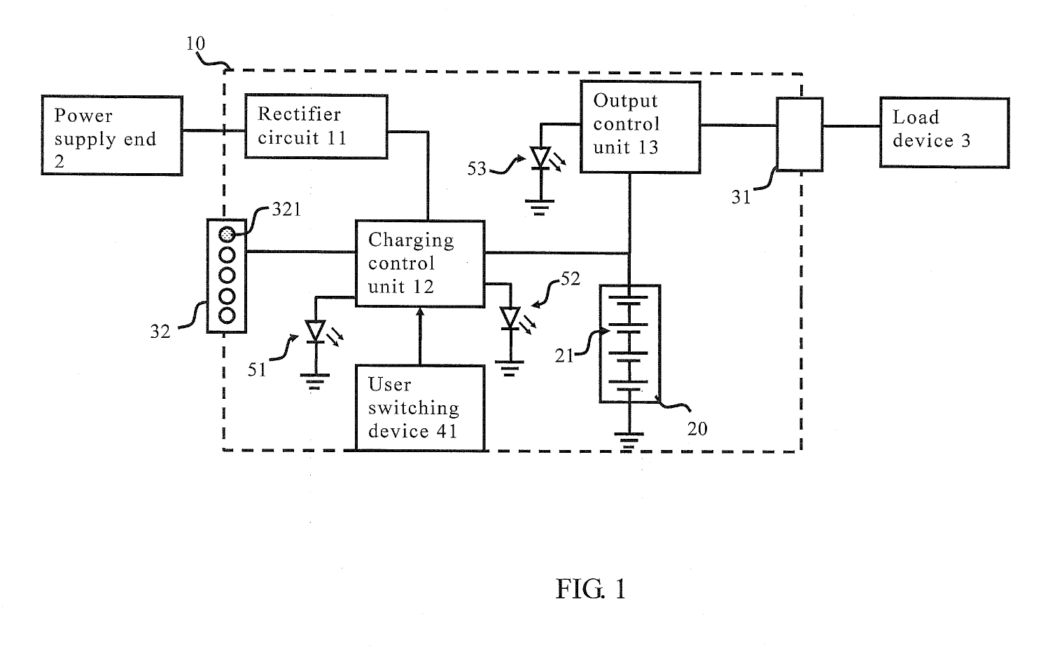

Please refer to FIG. 1 for the structure schematic drawing of the mobile power supply device of the present invention.

In the first embodiment of the present invention, the mobile power supply device 10 is electrically connected to the power supply end 2, to receive the alternating current power from the power supply end 2 for charging. The power supply end 2 may be the supply mains or other generator sets which can provide the alternating current power. Besides, the mobile power supply device 10 can output the direct current power to the load device 3 at the same time, allowing the load device 3 to work normally. The load device 3 can be a cell phone, a tablet computer, a notebook computer, or other similar electric devices, but the present invention is not limited to the abovementioned description.

The mobile power supply device 10 includes a rectifier circuit 11, a charging control unit 12, an output control unit 13, a battery set 20, a direct-current output port 31, and a direct-current input port 32. The abovementioned rectifier circuit 11, the charging control unit 12, and the output control unit 13 can be formed by a hardware, such as one chip or a plurality of chips; but the present invention is not limited to this design. The rectifier circuit 11 is electrically connected to the power supply end 2; therefore, when the power supply end 2 inputs the alternating current power, the rectifier circuit 11 converts the alternating current power to the direct current power. Because the method of converting the alternating current power to the direct current power of the present invention is well known to those of reasonable in the prior art of the field, and widely used in all kinds of electronic products, there is no need for further description.

The charging control unit 12 is electrically connected to the rectifier circuit 11 and the battery set 20, for controlling and protecting the battery set 20. Therefore, when the rectifier circuit 11 converts the alternating current power to the direct current power, the charging control unit 12 can charge the battery set 20; wherein the battery set 20 includes a plurality of series connecting battery units 21, therefore, when the direct current power charges, the direct current power can input the electricity to every battery unit 21 at the same time, to well reduce the charging time of the battery set 20. Besides, the charging control unit 12 may include the related protective function to protect the battery set 20, to prevent the battery unit 21 to be overcharged or over discharged. Because the method of preventing overcharging or over discharging is not the major object of the present invention, there is no need for further description.

The battery set 20 is also electrically connected to the output control unit 13 and the direct-current output port 31. The direct-current output port 31 can also be connected to the load device 3. The output control unit 13 is used for adjusting and controlling the battery set 20 to output the current and the voltage of the direct current power from the direct-current output port 31, to provide the direct current power in the constant voltage to the load device 3 via the direct-current output port 31, to charge the load device 3 safely and stably. At the same time, the mobile power supply device 10 includes the direct-current input port 32 which is electrically connected to the charging control unit 12 and the battery set 20. Therefore, the direct current power can be directly inputted via the direct-current input port 32, allowing the charging control unit 12 to charge the battery set 20. The direct-current input port 32 can be a Micro USB standard interface port, but the present invention is not limited to that design, the direct-current input port 32 can also be other standard interface port. The inside of the direct-current input port 32 can reserve a pin to be the determining pin 321, allowing the charging control unit 12 to use the determining pin 321 to determine the connecting position of the direct-current input port 32. For example, when the mobile power supply device 10 is connected to another same mobile power supply device 10 via the direct-current input port 32, the determining pin 321 of the direct-current input port 32 is grounded, such that the charging control unit 12 can determine the direct current power is input by another mobile power supply device 10, to charge the battery set 20. Besides, when inputting the direct current power or the alternating current power, the charging control unit 12 of the mobile power supply device 10 can request the battery set 20 to discharge at the same time, to achieve the function of synchronously charging and using.

The mobile power supply device 10 can further include a user switching device 41. The user switching device 41 is electrically connected to the charging control unit 12, allowing the user to directly control to charge or discharge the battery set 20. Besides, the mobile power supply device 10 can further include a charging status indicator 51, a battery indicator 52, and a power output indicator 53. The charging status indicator 51 is electrically connected to the charging control unit 12, for displaying the charging state of the battery set 20. The electric potential of the battery set 20 can feedback to the charging control unit 12 via the dividing circuit; at the same time the battery indicator 52 is electrically connected to the charging control unit 12, for displaying the current electricity state of the battery set 20. The power output indicator 53 is electrically connected to the output control unit 13, for displaying the discharging state of the battery set 20. Therefore, the user can know the current state of the mobile power supply device 10 more intuitively.

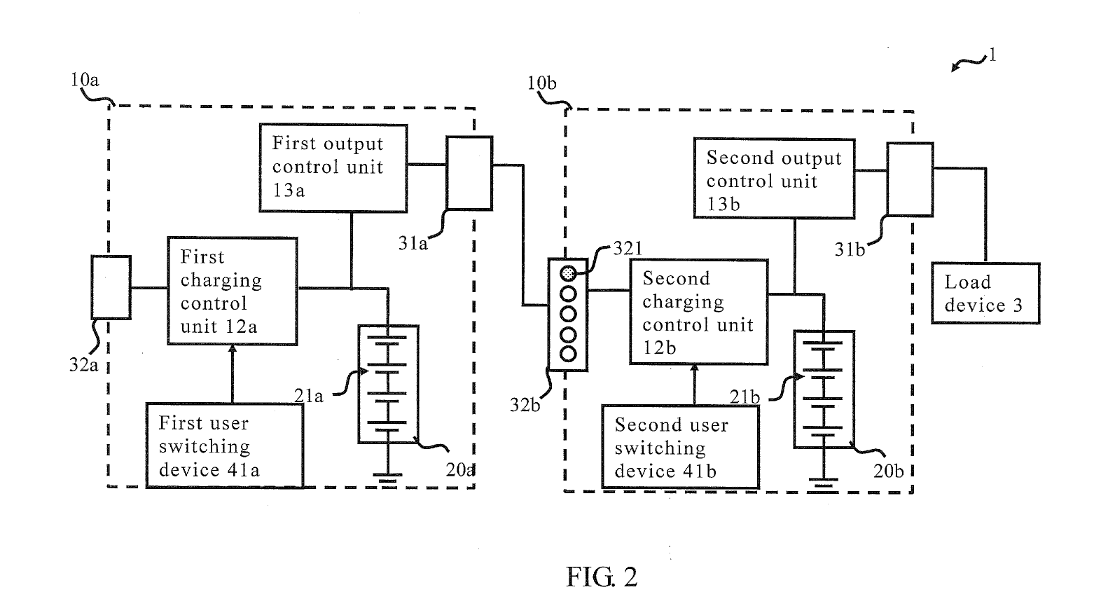

Please refer to FIG. 2 for the structure schematic drawing of the power supply system with the series connecting mobile power supply device of the present invention.

In the present invention, multiple mobile power supply devices 10 can be connected at the same time. For example, a first mobile power supply device 10a and a second mobile power supply device 10b are connected, to form a power supply system 1 to provide electricity. The first mobile power supply device 10a includes a first charging control unit 12a, a first output control unit 13a, a first battery set 20a, a first direct-current output port 31a, a first direct-current input port 32a, and a first user switching device 41a. The second mobile power supply device 10b includes a second charging control unit 12b, a second output control unit 13b, a second battery set 20b, a second direct-current output port 31b, a second direct-current input port 32b, and a second user switching device 41b. The above-mentioned elements are electrically connected to each other. Besides the abovementioned elements, the first mobile power supply device 10a and the second mobile power supply device 10b can also include the rectifier circuit 11, the charging status indicator 51, the battery indicator 52, and the power output indicator 53. Because the action mode of the rectifier circuit 11, the charging status indicator 51, the battery indicator 52, and power output indicator 53 are already descripted in the abovementioned description, there is no need to for further description.

When the first mobile power supply device 10a is connected to the second mobile power supply device 10b, the first direct-current output port 31a of the first mobile power supply device 10a is connected to the second direct-current input port 32b of the second mobile power supply device 10b. Therefore, the first output control unit 13a controls the first battery unit 21a of the first battery set 20a to discharge, to directly output the first battery set direct current power. Meanwhile, the first direct current power passes the second direct-current input port 32b, to input the electricity to the second battery set 20b via the second charging control unit 12b. If the second mobile power supply device 10b needs to charge the load device 3 at the same time, the second output control unit 13b will control the second battery set 20b to output the second direct current power via the second direct-current output port 31b.

At this moment, via the determining pin 321 of the second direct-current input port 32b, the second charging control unit 12b can determine whether the source of the first direct current power is the same first mobile power supply device 10a. Therefore, the first output control unit 13a of the first mobile power supply device 10a can directly output all the voltage and the electricity of the first battery set 20a, and the second charging control unit 12b can control the second battery set 20b to receive all the voltage and the electricity of the first battery set 20a when receiving the first direct current power, then the electricity can output a double second direct current power from the second direct-current output port 31b. The first battery unit 21a in the first battery set 20a and the second battery unit 21b in the second battery set 20b are series connected, therefore, the first mobile power supply device 10a is connected to the second mobile power supply device 10b, is equivalent to that the plurality of first battery units 21a are directly series connect to the plurality of second battery units 21b. Therefore, the maximum output electricity of the second direct current power is the sum of the electricity of the first battery set 20a and the electricity of the second battery set 20b, and the output current can also increase. Besides, the first mobile power supply device 10a can series connect other mobile power supply device 10 via the first direct-current input port 32a, to adjust the current and electricity of the maximum output direct current power.

The first user switching device 41a and the second user switching device 41b allowing the user to operate to respectively decide if the first mobile power supply device 10a and the second mobile power supply device 10b need to be charged or discharged. Therefore, the user can uses the first user switching device 41a and the second user switching device 41b to decide the output current and the output electricity of the final second direct current power.

Besides, via the abovementioned series connecting method of the plurality of the battery units 21 of the mobile power supply device 10, the whole battery set 20 can have a higher potential, such that the battery set 20 can easily reduce the voltage to the potential requested by the load device 3 via the output control unit 13, and keep output large current. Via the switching of the user switching device 41, the power supply system 1 of the present invention can provide the power signal of different potential to the suitable load device 3. Such as outputting 5 volts, 12 volts, or 19 volts to fit the requiring voltage of different kinds of load device 3 for those kinds of load device 3. If the device of the prior art upward boost outputs the high voltage from a 3.7 volts battery, the cost will substantial increase; besides, it is impossible to increase more than five times the voltage to an electric potential to charge a notebook computer.

It is noted that the above-mentioned embodiments are only for illustration. It is intended that the present invention cover modifications and variations of this invention provided they fall within the scope of the following claims and their equivalents. Therefore, it will be apparent to those skilled in the art that various modifications and variations can be made to the structure of the present invention without departing from the scope or spirit of the invention.

What is claimed is:

1. A mobile power supply device, used for receiving an alternating current power from a power supply end, and charging a load device, the mobile power supply device comprising:
a rectifier circuit, used for receiving the alternating current power to convert to a direct current power;
a battery set, comprising a plurality of battery units which are series connected to each other;
a charging control unit, electrically connected to the rectifier circuit and the battery set for receiving the direct current power to charging the battery set;
an output control unit, electrically connected to the battery set for adjusting and controlling the battery set to output a current and a voltage of the direct current power to the load device via a direct-current output port; and
a direct-current input port, electrically connected to the charging control unit and the battery set for inputting the direct current power to the battery set, wherein the direct-current input port comprises a determining pin, the charging control unit determines whether the charging control unit is connected to another mobile power supply device via the determining pin, to further control the battery set to receive the direct current power from another mobile power supply device.

2. The mobile power supply device as claimed in claim 1, further comprising an user switching device for allowing a user to operate for controlling the battery set to charge or discharge.

3. The mobile power supply device as claimed in claim 1, wherein the charging control unit is electrically connected to a charging status indicator for displaying a charging state of the battery set.

4. The mobile power supply device as claimed in claim 1, wherein the battery set is electrically connected to a battery indicator for displaying an electricity state of the battery set.

5. The mobile power supply device as claimed in claim 1, wherein the output control unit is electrically connected to a power output indicator for displaying a discharging state of the battery set.

6. The mobile power supply device as claimed in claim 1, wherein the direct-current input port is a Micro USB standard interface port.

7. A power supply system, used for charging a load device, the power supply system comprising:
a first mobile power supply device comprising:
a first battery set comprising a plurality of first battery units which are series connected to each other; and
a first output control unit electrically connected to the first battery set for controlling the first battery set to output a first direct current power via a first direct-current output port; and
a second mobile power supply device electrically connected to the first mobile power supply device, the second mobile power supply device comprising:
a second battery set comprising a plurality of second battery unit which are series connected to each other;
a charging control unit electrically connected to the second battery set;
a direct-current input port electrically connected to the charging control unit and the second battery set, wherein the direct-current input port comprises a determining pin, the charging control unit determines whether the second mobile power supply device is connected to the first mobile power supply device via the determining pin, to further control the second battery set to receive the first direct current power from the first mobile power supply device; and
a second output control unit electrically connected to the second battery set for controlling the second battery set to output a second direct current power to the load device via a second direct-current output port.

8. The power supply system as claimed in claim 7, wherein the first mobile power supply device further comprises a first user switching device, the second mobile power supply device further comprises a second user switching device, the first user switching device and the second user switching device are used for allowing a user to operate to control the first mobile power supply device and the second mobile power supply device to charge or discharge.

9. The power supply system as claimed in claim 8, wherein the first user switching device and the second user switching device are used for allowing the user to operate to decide an output voltage of the second direct current power.

10. The power supply system as claimed in claim 9, wherein a maximum capacity of the second direct current power is a sum of a capacity of the first battery set and the second battery set.

11. The power supply system as claimed in claim 7, wherein the direct-current input port is a Micro USB standard interface port.
